(19) United States
(12) Patent Application Publication
(10) Pub. No.: US 2011/0216172 A1
(43) Pub. Date: Sep. 8, 2011

(54) Cross talk reduction technique

(75) Inventor: Louis Joseph Kerofsky, Camas, WA (US)

(73) Assignee: Sharp Laboratories of America, Inc.

(21) Appl. No.: 12/660,872

(22) Filed: Mar. 5, 2010

(51) Int. Cl. H04N 13/04

(52) U.S. Cl. 348/53; 348/54; 348/E13.075

(57) ABSTRACT

A method for reducing cross talk for a video displayed on a liquid crystal display includes addressing a portion of the liquid crystal display with data for first and second frames for a left view and a right view of a stereoscopic pair of images while a backlight of the liquid crystal display is free from illuminating the liquid crystal display. Illuminating the addressed portion of the display for the left view and the right view with the backlight after the addressing of the liquid crystal display. Wherein the addressing and the illumination occurs within respective frames of the video.

### CROSS-REFERENCE TO RELATED APPLICATIONS

Not applicable.

### BACKGROUND OF THE INVENTION

The present invention relates generally to a stereoscopic display which provides different views to each eye of a viewer. More specifically, views are interleaved temporally alternating between eyes of a viewer wearing active glasses which alternately block an individual eye in synchronicity with the alternating frame displayed by the display.

A stereoscopic three dimensional display typically provides a viewer with parallax images in a time sequential manner from the right eye viewpoint and the left eye viewpoint. There are two principal techniques to provide the two eyes of the viewer with the images. One technique utilizes three dimensional glasses which selectively transmit light to the viewer's eyes in synchronization with the left and right images. Another technique utilizes a right eye viewpoint and a left eye viewpoint that are alternatively displayed to the respective eyes of the viewer but without using glasses.

A liquid crystal display (LCD) is a sample and hold device, where the image at any pixel of the display is stable until that pixel is updated at the next image refresh time. In such a sample and hold display, requires careful timing sequencing of the light sources so that, for example, the left eye image light source is not on during the display of data for the right eye and vice versa. Typically, cross talk results from simultaneously viewing portions of the left and right images.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an active glass based stereoscopic display.

FIG. 2 illustrates a duty cycled lens.

FIG. 3 illustrates a display response.

FIG. 4 illustrates LCD addressing and response with interleaved views.

FIG. 5 illustrates cross talk with active glasses and LCD addressing.

FIG. 6 illustrates fast LCD addressing.

FIG. 7 illustrates parallel addressing from the center outward.

FIG. 8 illustrates a frame buffer.

FIG. 9 illustrates buffering with parallel addressing.

FIG. 10 illustrates addressing needs for parallel addressing.

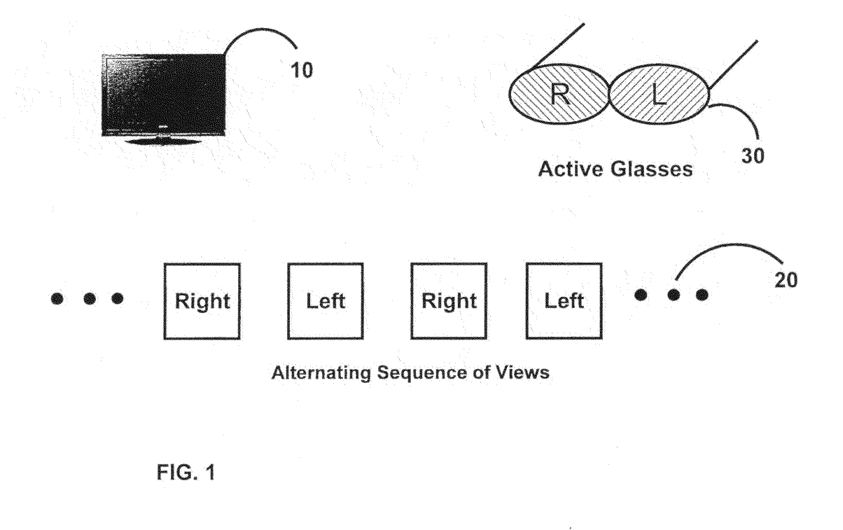

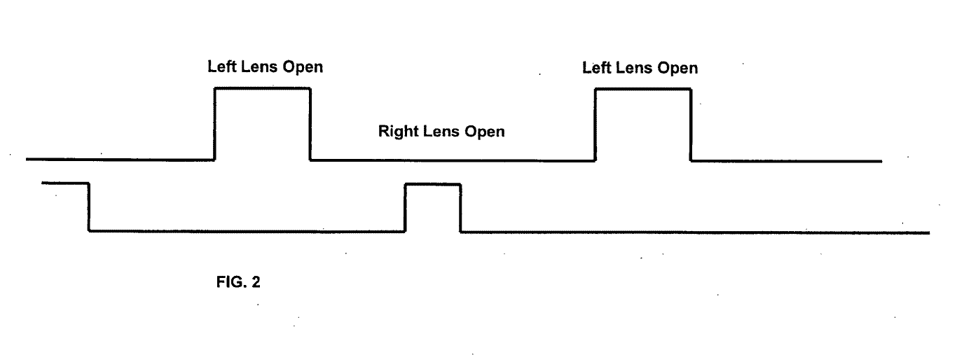

### DETAILED DESCRIPTION OF PREFERRED EMBODIMENT

To provide a stereoscopic view, a display 10 may provide an alternating sequence of views 20. For example, the views may be a sequence of right, left, right, left, etc. In other cases, the views may be a sequence of right, right, left, left, right, right, left, left, etc. Yet in other cases, the views may be a sequence of right, right, left, right, left, left, right, right, etc. Any other sequence of left and right images may likewise be used. In addition to providing the left and right images, a pair of active glasses 30 are provided, which are synchronized to the display in any manner, such that they provide alternating views of the left image to the left eye (or right eye) and right image to the right eye (or left eye).

In general it is desirable to reduce the cross talk between the views, e.g., some of the image intended for one eye is observed by the other eye, or some of the right image (or vice versa) is included with the desired left image (or vice versa) when viewed by the left eye (or right eye). One technique to attempt to reduce the cross talk between the eyes is to use active glasses with a very fast response time that is turned off and on and off very quickly. This reduces the time available for data from one view being passed to the unintended eye by reducing the number of lines with the opposite view. Due to addressing time limitations, the pixel data is not globally available for a single image at the same instant in time. This remains an issue even with glasses having instantaneous response.

Two fundamental issues of stereoscopic displays include reduction in brightness of each view as the available time for forming an image is decreased, and wasted energy used to generate light as the fraction of time when both lenses are closed.

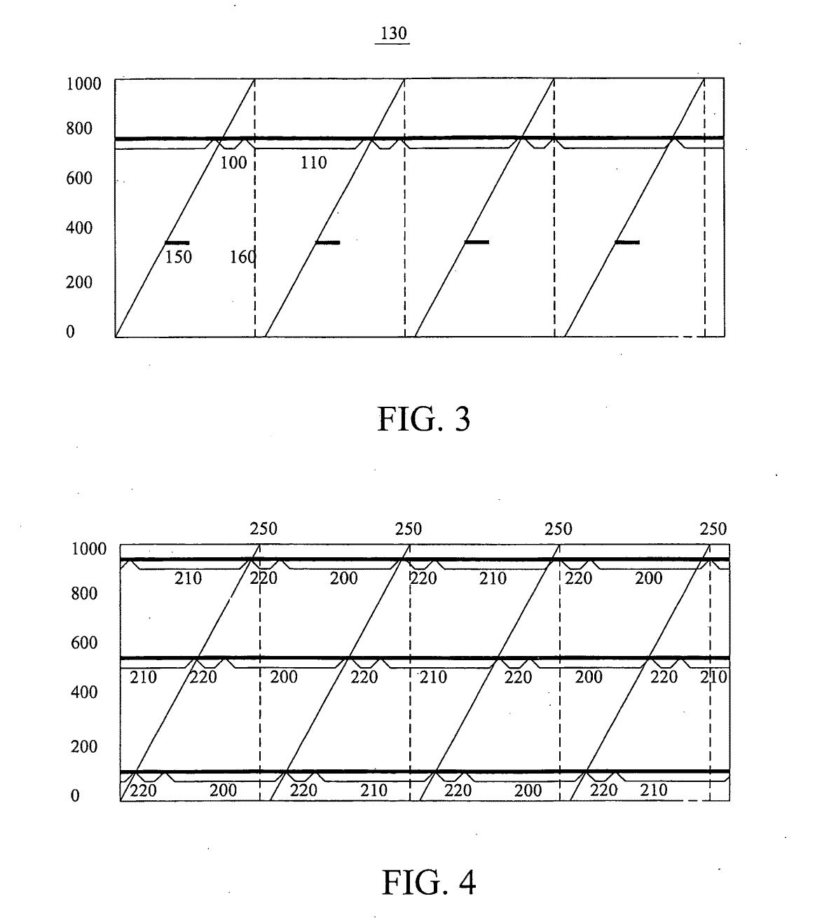

It may be observed that the addressing and response time of the display are limitations to cross talk reduction. In a conventional liquid crystal display or other conventional displays (i.e. PDP or CRT) the image is not available at a single time but rather the image is drawn onto the display over a nonzero amount of time. Limitations on the addressing circuitry and internal memory bandwidth dictate a non-zero addressing time for such a display. In general, displays may be further classified as hold type displays or impulsive type displays. In the hold type display, once the data is written to the pixels of the display, the value at the pixels are held until replaced by a different value at a temporally later time. In the impulsive type display, such as CRT or PDP, the data written to the pixels of the display are illuminated briefly after the pixel is written, then the pixels go dark. The impact of addressing schemes and the hold type display of an LCD is compared with an impulsive type display in FIG. 3. The horizontal axis is the display time assuming a 120 Hz display, i.e. frame time of 8.3 ms with each frame normally presented at 60 Hz rate. The vertical axis shows the line of the display being addressed. As it may be observed, the addressing of the display occupies nearly all of the frame time with the exception of a small vertical blanking interval originally included to account for a retrace time inherent to CRT display technology.

Two sample lines are selected to show the difference in behavior of the response time and hold time of the LCD display, and the impulsive character of the CRT display. The LCD display is shown at roughly line 700. When the line is addressed by the addressing scheme 130, the LC begins to respond 100. The response time 100 is generally the time it may take for the liquid crystal material to change its state to a new pixel value (the actual response time may be shorter or longer). After the response time 100, the display value is held 110 until it is addressed again. It is noted that the pixel values at line 700 are held until the line is readdressed, even though a new frame has begun as illustrated by the start of addressing of the first line of the display.

In contrast to the LCD hold type character, an impulsive type display is illustrated at roughly line 350. When the line is addressed, the display output 150 assumes the desired value very quickly. After a brief time 150, the addressed pixel ceases to emit light as indicated during the time 160.

Unfortunately, the hold type character of the display typically results in significant motion artifacts in comparison to the impulsive type display, when viewing stereoscopic content using active glasses. In order to reduce motion artifacts and reduce cross talk when viewing stereoscopic image content, the hold type characteristics of the display may be used to allow an entire frame of data to be available at the same time for each view of the stereoscopic display. The undesirable attributes of the hold type behavior of the display can be reduced by selectively illuminating the backlight during different time intervals. With a LCD display having a backlight that may illuminate different lines or groups of lines (less than all lines) in a sequential manner, the backlight is illuminating the pixels only during or shortly after those lines have been addressed. Thus the lines with active backlight scroll vertically following the corresponding pixel addressing. This manner of illumination of a hold type display generally mimics an impulsive type display, although the LCD holds the addressed value which is only observed when the corresponding backlight region is illuminated. It is noted that a stereoscopic display based on active glasses is intrinsically a global process where an entire view is active at the same time.

Referring to FIG. 4, the impact of LCD addressing with active glasses used for a stereoscopic display is illustrated. The addressing and hold type display response is illustrated at three different lines. The horizontal axis is the display time assuming a 120 Hz display, i.e. frame time of 8.3 ms. The vertical axis shows the line of the display being addressed. The addressing occupies nearly all of the frame time with the exception of a small vertical blanking interval originally introduced to account for retrace of a CRT display. The three delineated lines are selected to illustrate the temporal offset of the corresponding displayed values resulting from the display addressing, the LC response time, and the hold effect. The display interleaves the left and right views temporally. The display has stable values for the left view 200. The display has stable values for the right view 210. There are time periods between the stable left and the stable right views indicated as LC transition times 220. As illustrated, each line has a repetitive structure of the stable left view, the transition period, the stable right view, the transition period, etc. In addition, the different time periods are also temporally offset in time when different rows are addressed. By way of example, during the vertical blanking time 250, the lower lines have stabilized (200, 210) while the upper lines are still in transition (220). It may be observed that during any interval of time some lines are holding the left view, some lines are in the transition period, and some lines are holding the right view.

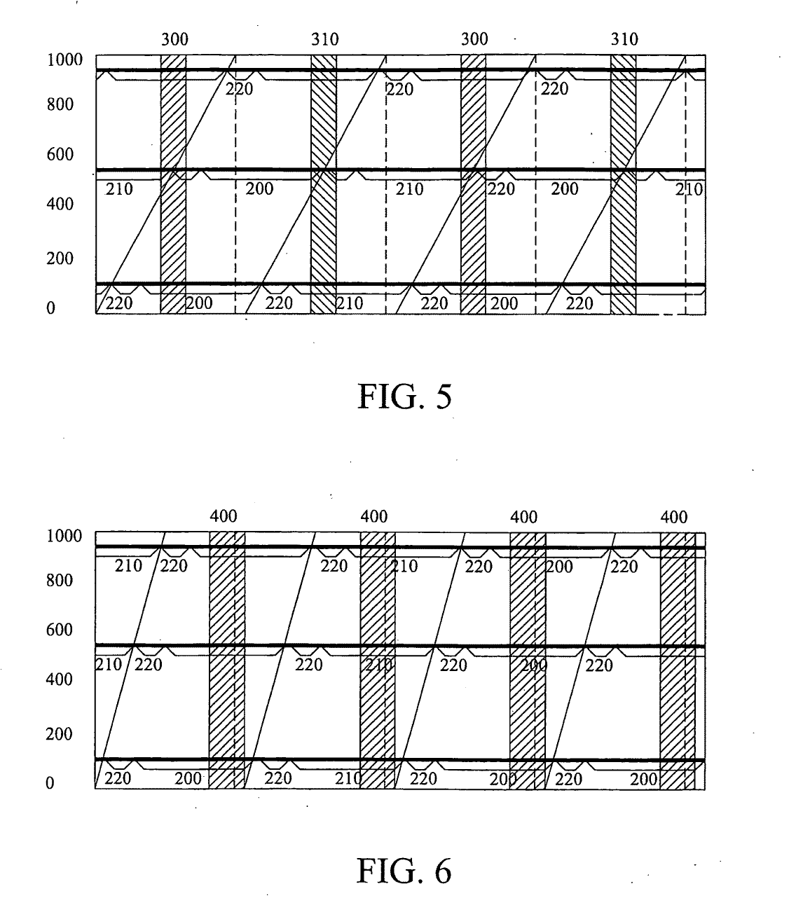

With the characteristics of the hold type display illustrated, the inclusion of active glasses 30 is illustrated in an attempt to isolate individual views for each eye. Referring to FIG. 5, the interaction of the duty cycle of the active glasses 30 is shown with respect to alternate views between the right eye and the left eye. FIG. 5 results from FIG. 4 being overlaid with data for the active time of the left lens 300 and the right lens 310 of the glasses 30. Cross talk can be seen for example when the left lens 300 is open but the line of the LCD is holding data intended for the right eye. This is seen for example on the upper line near 5 ms. Likewise cross talk through the right lens 310 can be seen on the same line at 12 ms. The unstable region of the LCD is visible where the middle line intersects the respective left open lens or right open lens. The cross talk of a particular line can be removed (or otherwise reduced) by adjusting the opening/closing time of each of the right eye lens and the left eye lens. However, similar cross talk will be caused at other lines in the display as a result. This cross talk effect cannot be eliminated as long as all the data for a single view is not on the display for the entire time the lens is open. Limits on the response time of the glasses and the delay of the LC addressing and response make cross talk inevitable. Faster glasses and shorter duty cycles can somewhat mitigate the effect but are limited in what they can achieve.

To reduce this inherent cross talk limitation a combination of LCD addressing and backlight addressing may be used. The LCD is addressed for a frame in a shorter time than typical, such as for example half a frame time, while the backlight is off. The backlight remains off until after the addressing has finished and the LC has had some time to respond to the new data. The backlight is turned on during the remaining portion of the frame, or a portion thereof. With this combination, the responsive demands on the active glasses may be reduced since the state of the right lens and/or the left lens is generally unimportant when the backlight is turned off. The appropriate lens may begin to open as soon as the backlight from the previous alternate view is turned off. The appropriate lens does not need to stabilize until the backlight for the current frame is activated, typically over ¼ a frame time later. Once the backlight is off, the lens does not need to close until the next backlight cycle, again typically more than ¼ a frame later. Since the backlight is only generating light while a lens is open, there is less energy loss, in comparison to techniques which use excessively short duty cycles for the glasses with a backlight that is always on.

Referring to FIG. 6, an illustration of the limited duration backlight 400 with fast line addressing is shown. The vertical axis on the left indicates the line being addressed while the horizontal axis is the display time with 8.3 ms corresponding to one frame at 120 Hz. Note that the addressing completes in half a frame time and the backlight is off during the addressing and response time. The backlight 400 is shown with a 25% duty cycle and is active in the last 25% of the frame. In this example, only data from a single view is present on the display when the backlight is active.

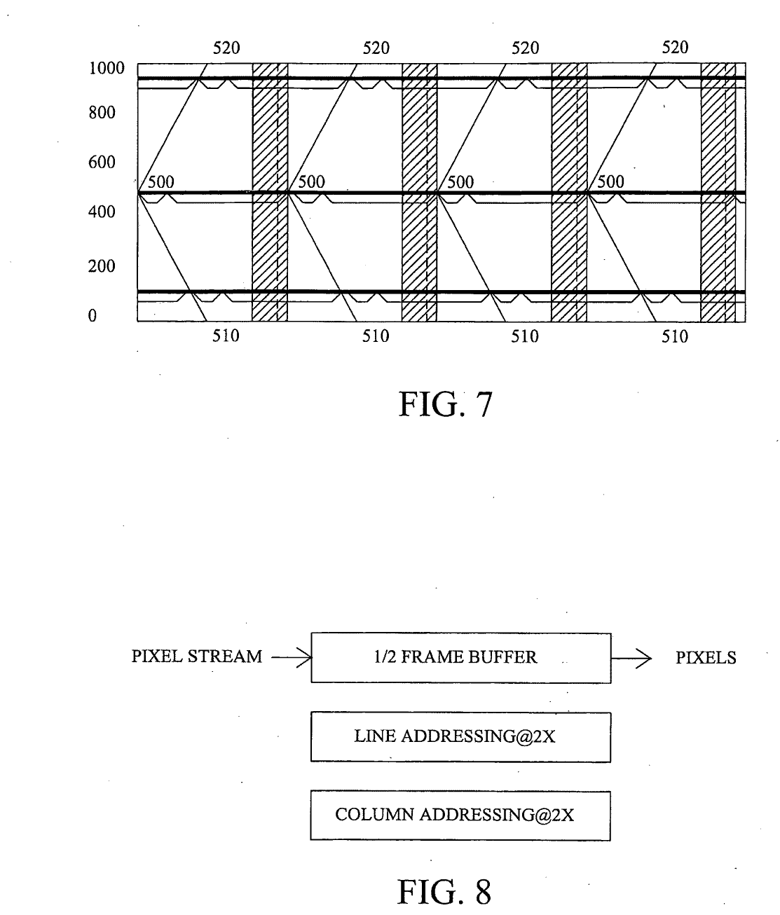

The fast addressing technique may require the line addressing to operate at a higher rate than it would otherwise operate, such as twice the rate. Another approach is to operate multiple addressing circuits in a parallel fashion to address the same total number of lines in less time, such as twice the addressing circuits addressing the lines in half the time. This approach reduces the operating speed since the line addressing elements may operate at a lower rate. Referring to FIG. 7, the addressing technique preferably starts from the center of the display outward, i.e. one starts at the center 500 and goes down 510 while the other starts at the center 500 and goes up 520. Starting at the center permits the center portions of the screen a longer time to respond before the backlight is activated, thus possibly reducing artifacts that would have otherwise occurred if such a longer time was not provided.

Referring to FIG. 8, with both “fast” addressing and/or parallel addressing there is a need to buffer data. In general, a half frame of buffered data is sufficient for either approach. With the fast addressing approach, half a frame is buffered before the output begins removing data from the buffer and writing the data to the display. Once the buffer is full, the output begins removing data at a rate twice the rate at which data enters the buffer. After half a frame time of addressing an entire frame has been written to the display and the buffer is emptied. The process repeats for the next frame with half of the frame buffered before beginning to empty the frame at twice the input rate. In addition to the ½ frame buffer, the fast addressing may use line and column addressing which can operate at twice the typical rate.

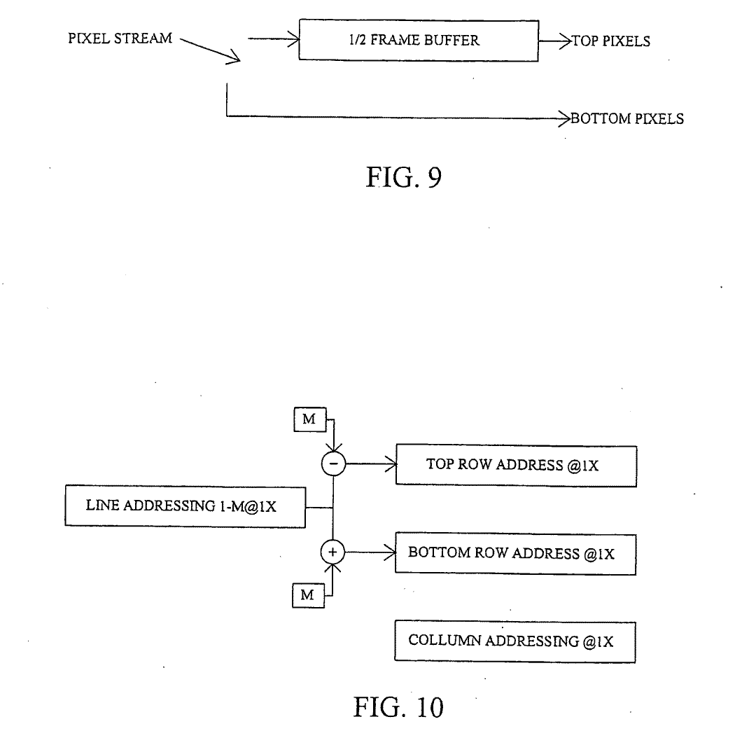

Referring to FIG. 9, with the parallel addressing approach, half a frame is buffered before output begins removing data from the buffer and writing it to the display. Once the buffer is full, two addressing operations run in parallel. One process copies data from the buffer to the display. In a preferred embodiment this data is copied from the middle outward. The second process takes data directly from the source and directs it to the display. After half a frame time, the buffer is empty and the source has completed an entire frame. The process begins again by buffering the first half of the next frame.

Referring to FIG. 10, in addition to the buffer, the parallel approach may generate two lines of addressing signals. The column addressing signal can be shared. The line addressing signals may be derived from a common source operating at normal speed but for only half time. Offsets to the value may be used to generate the two parallel addressing signals. The column addressing can be shared. Note that the speed of the addressing circuits is not increased compared to a traditional solution.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for reducing cross talk for a video displayed on a liquid crystal display comprising:
(a) addressing a portion of said liquid crystal display with data for a first frame for a left view of a stereoscopic pair of images while a backlight of said liquid crystal display is free from illuminating said liquid crystal display;
(b) illuminating said addressed portion of said display for said left view with said backlight after said addressing of said portion of said liquid crystal display;
(c) wherein said addressing and said illuminating for said left view occurs within a single frame of said video;
(d) addressing a portion of said liquid crystal display with data for a second frame for a right view of said stereoscopic pair of images while said backlight of said liquid crystal display is free from illuminating said liquid crystal display;
(e) illuminating said addressed portion of said display for said right view with said backlight after said addressing of said portion of said liquid crystal display;
(f) wherein said addressing and said illuminating for said right view occurs within a single frame of said video.

2. The method of claim 1 wherein said addressing for said left view is all of the pixels for said left view.

3. The method of claim 2 wherein said addressing for said right view is all of the pixels for said right view.

4. The method of claim 2 wherein said illuminating for said left view is all of said pixels for said left view.

5. The method of claim 4 wherein said illuminating for said right view is all of said pixels for said right view.

6. The method of claim 1 wherein glasses are synchronized to said illuminating of said right view and said left view.

7. The method of claim 1 wherein said addressing for said left view is all of the pixels for said left view; said addressing for said right view is all of the pixels for said right view; said illuminating for said left view is all of said pixels for said left view; and said illuminating for said right view is all of said pixels for said right view.

8. The method of claim 1 wherein said addressing of said left view is performed in less than half a frame time of said video.

9. The method of claim 8 wherein said frame rate of said video is 60 Hz.

10. The method of claim 8 wherein said frame rate of said video is 120 Hz.
